(19) United States
(12) Patent Application Publication
(10) Pub. No.: US 2007/0165255 A1
(43) Pub. Date: Jul. 19, 2007

(54) Image forming device

(75) Inventor: Naoki Takeuchi, Osaka (JP)

Correspondence Address: Kyocera Technology Development;Intellectual Property Administration, Suite 400, 1855 Gateway Blvd., Concord, CA, 94520, US

(73) Assignee: Kyocera Mita Corporation, Osaka-shi (JP)

(21) Appl. No.: 11/652,253

(22) Filed: Jan. 10, 2007

(30) Foreign Application Priority Data
Jan. 18, 2006 (JP) JP2006-010446

(51) Int. Cl. G06F 15/00

(52) U.S. Cl. 358/1.9; 358/504

(57) ABSTRACT

A method, program product, and system for a color image forming device that enables controlling a calibration during a sequential print job while performing a calibration in a timely manner. The color image forming device includes a print means, a calibration execution unit, a page count unit, and a print job monitoring means. A calibration is not performed when a sequential print job is being processed even if the print page value has exceeded a threshold value, and the print job is continuously processed. A calibration is performed when the print page value has exceeded a second threshold value even if there is a printing job or a waiting print job.

### FIELD OF INVENTION

The present invention relates to an image forming device capable of color print output, in particular to optimization of execution time of calibration (toner density adjustment) necessary for correction of toner density.

### BACKGROUND OF THE INVENTION

Generally, a color image forming device executes calibration processing regularly or according to a set trigger condition in order to control a change in toner density due to a development and/or an environment change and thereby assure reproductivity of color gradation. The calibration creates on a drum or a transfer belt a patch pattern which serves as a base for toner density adjustment without actually printing the pattern on a paper, measures the toner density of the patch pattern with an optical detection device, and determines an adjustment value based on the difference between the standard toner density and the toner density of the patch pattern.

Such calibration, when executed, makes the image forming device unavailable for the users to use and causes them inconvenience. However, continuous printing without a calibration will start causing inconsistency in toner density, and thus will deteriorate quality of an output image. Alternatively, frequent calibration, when performed more than necessary, wastes toner by creating a patch pattern each time. Therefore, a calibration is better to be performed as necessary yet without hindering usability, as minimally as possible.

Conventionally, as described in Japanese Patent No. 2984400, when sequential “N” pages of printing is requested and the value N is bigger than the print page value “n” for executing an optimal sequential printing operation, an image forming device of this type performs n pages of printing, then performs a calibration, resets a value derived by subtracting n from N (N−n) as the new value N, and continues the processing. Alternatively, Japanese Patent Application Laid-Open No. 7-261479 discloses a method for cumulatively counting an input print page value since a last calibration operation and performing a calibration at the time when the cumulatively counted print page value exceeds a threshold value.

However, such conventional methods perform calibration during a sequential print job and cause inconsistency in print quality between pre- and post-calibration. Moreover, execution of a calibration during a print job necessitates the user to wait and causes inconvenience.

The issues the present invention intends to address are that execution of a calibration on an image forming device during a sequential print job causes inconsistency in print quality between before and after calibration as well as inconvenience to the user.

### SUMMARY OF THE INVENTION

An object of controlling calibration during a sequential print job while performing a timely calibration is accomplished by implementing a print page count means and a print job monitoring means on an image forming device.

More specifically, an image forming device which forms a color image by overlaying each toner image of different color on a transfer unit, an image forming device of the present invention, in order to control calibration during a sequential print job while performing a calibration in a timely manner, comprises: a print means for performing print processing of a print job; a calibration implementation means for performing a calibration on the print means; a print page count means for counting a print page value; a print job monitoring means for monitoring whether a following print job is waiting; and a calibration control means for instructing the calibration implementation means to execute a calibration when the print page value counted by the print page count means has exceeded a designated threshold value and the print job monitoring means verifies that there is not a waiting print job. Accordingly in this configuration, calibration will be controlled when printing of a print job is being executed and/or a print job is waiting. Thus, neither will print quality differ before and after calibration, nor will the user experience inconvenience and frustration.

These and other objects, features and advantages of the present invention are specifically set forth in or will become apparent from the following detailed descriptions of the invention when read in conjunction with the accompanying drawings.

### DESCRIPTION OF THE DRAWINGS

FIG. 1 is block configuration diagram of an image forming device of the present invention.

FIG. 2 is a flowchart describing an execution operation which embodies an aspect of the present invention.

FIG. 3 is a flowchart describing an execution operation which embodies another aspect of the present invention.

### DETAILED DESCRIPTIONS OF THE INVENTION

Exemplary embodiments of the present invention are explained below with reference to the accompanying drawings though these embodiments are not intended to limit the invention. Additionally, in some instances, well-known structures, interfaces, and processes have not been shown in detail in order not to unnecessarily obscure the present invention.

A first preferred embodiment of the present invention illustrates an aspect of an image forming device of the present invention.

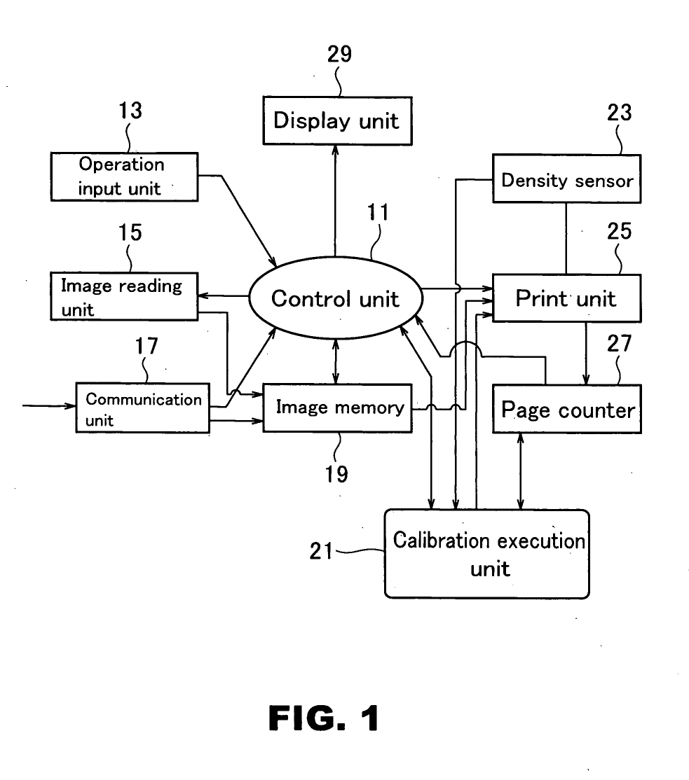

FIG. 1 is a block configuration diagram of the first preferred embodiment of the present invention. The image forming device comprises an operation input unit 13, an image reading unit 15, a communication unit 17, an image memory 19, a calibration execution unit 21, a density sensor 23, a print unit 25, a page counter 27, a display unit 29, and a control unit 11.

The operation input unit 13 provides an instruction through an operation panel on print functions. The image reading unit 15 reads an image through a scanner device. The communication unit 17 performs communication with a computer and a network. The image memory 19 stores an image read at the image reading unit 15 and an image sent from a network through the communication unit 17.

The calibration execution unit 21 as a calibration implementation means performs a calibration for correcting inconsistency of toner density for color-printing. The density sensor 23 reads a toner density of a patch pattern formed on a transfer belt for calibration. The print unit 25 provides a print means for performing print processing of a print job. The page counter 27 provides a print page count means for counting a print page value. The display unit 29 locates itself on an operation panel and displays an operation guide and a status of a device.

The control unit 11 comprises a CPU (central processing unit) and peripheral control circuits which control each of the aforementioned units, and according to a configured program, functions as a print means, a print page count means, a print job monitoring means, and a calibration control means.

As a print means, the control unit 11 performs printing by issuing a command to the print unit 25, based on a copy instruction input from the operation input unit 13 and a print instruction from a computer connected through the communication unit 17.

As a print page count means, the control unit 11 counts a print page value using the page counter 27 upon performance of printing by the print unit 25.

As a print job monitoring means, the control unit 11 monitors if there is a waiting print job by monitoring inputs from the operation input unit 13 and the communication unit 17.

Alternatively, as a calibration control means, the control unit 11 determines if the print page value counted by the page counter 27 has exceeded a set threshold value n. When the print page value has exceeded the value n and a print job is not waiting, the control unit 11 instructs the calibration execution unit 21 to execute a calibration.

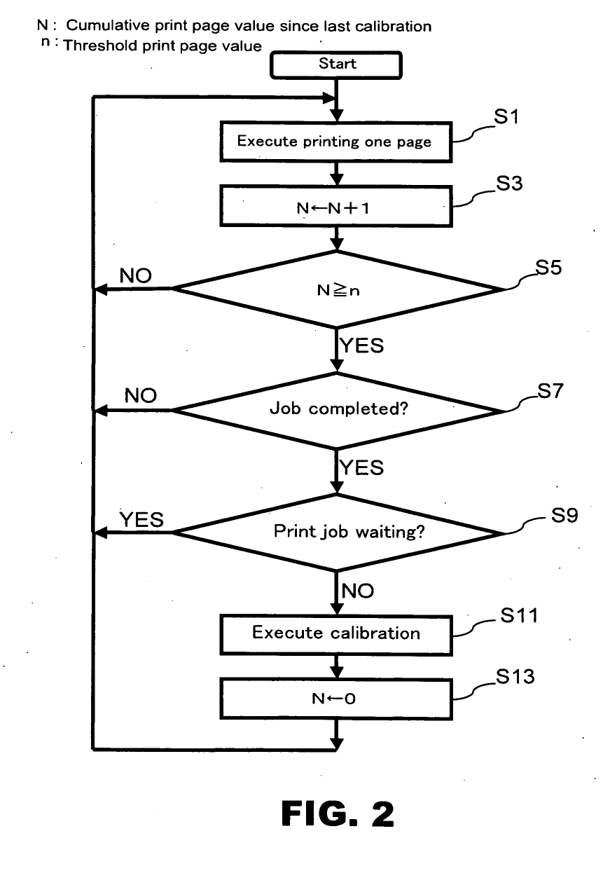

The following describes operation of a calibration using a flowchart illustrated in FIG. 2.

Upon start of operation of an image forming device, step S1 to print one page is executed.

Upon execution of step S1, operation executes step S3 to add the print page value “1” to a count value N counted by the page counter 27. A default value of N is set to “0.”

Next, operation executes step S5 to determine whether the cumulative print page value N since the last calibration is equal to or more than the threshold value n. When a result of step S5 is “NO,” namely the print page value has not exceeded the threshold value, the program returns to step S1 and repeats step S1 to print one page, step S3 to add the print page value “1” to the page counter, and step S5 to determine whether the value N is equal to or more than the value n.

When a result of step S5 is “YES,” operation executes step S7 for the control unit 11 to check the status of the print unit 25 and determine whether all pages of a job have been printed and the job has been completed. When a result of step S7 is “NO,” that is, printing of an executing job has not been completed, operation returns to step S1 and repeats the subsequent steps.

When a result of step S7 is “YES,” operation executes step S9 for the control unit 11 to identify the status of the operation input unit 13 and the communication unit 17 to determine whether there is a waiting print job instructed for print output. When a result of step S9 is “YES,” more specifically, there is a waiting print job, operation returns to step S1 and repeats the subsequent steps.

When a result of step S9 is “NO,” operation executes step S11 to execute a calibration by determining that it is the appropriate time for executing a calibration, based on the results of a series of conditioning steps that the print page value has exceeded the threshold value and that there is neither a printing job nor a waiting job.

Then, operation executes step SI 3 to reset the cumulative print page value N since the previous calibration, which is stored in the page counter 27, to complete a series of calibration operation, then returns to the first step and repeats the subsequent steps.

The first preferred embodiment of an image forming device of the present invention does not execute a calibration during a sequential printing process, and thereby a change of image quality due to calibration does not occur in the middle of a print job processing. Moreover, since the first preferred embodiment of an image forming device of the present invention does not execute a calibration when there is a waiting job, the user will be spared from inconvenient wait time for a print start due to calibration.

The following describes a second preferred embodiment of an image forming device of the present invention, which embodies another aspect of the present invention.

Configurations of the second preferred embodiment of the present invention are the same as the ones of the first preferred embodiment illustrated with the block configuration diagram in FIG. 1.

However, when the control unit 11 of the second preferred embodiment of the present invention functions as a calibration control means, even when a print page value has exceeded a first threshold value n and there is a waiting job, if the print page value has exceeded a second threshold value “(n+P),” which is the first threshold value n plus a print page value P which is the print page value exceeding the first threshold value n, the control unit 11 instructs the calibration execution unit 21 to execute a calibration regardless of presence or absence of a waiting print job.

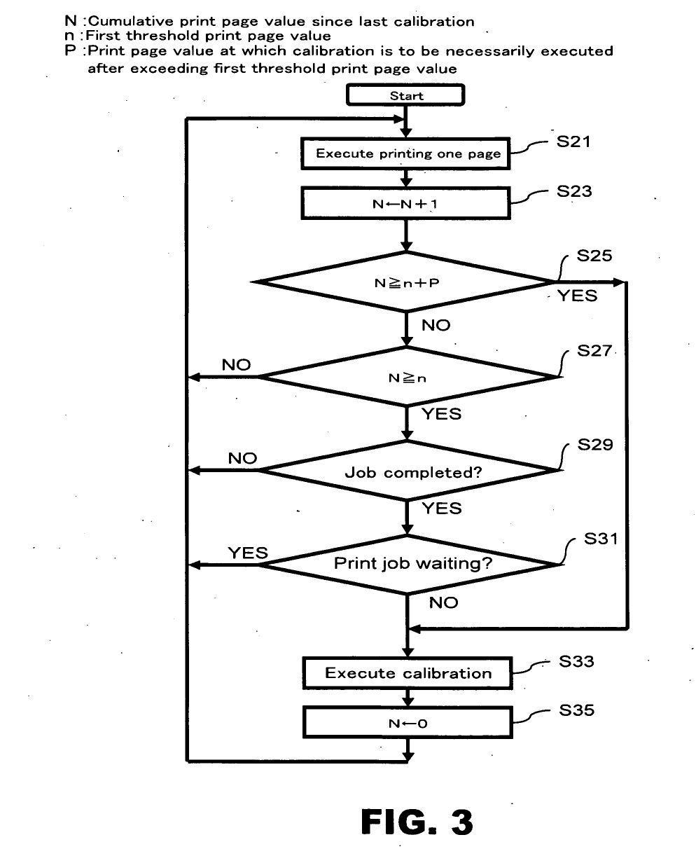

Operation of a calibration of the second preferred embodiment will be described with a flowchart in FIG. 3.

Upon start of operation of an image forming device, operation executes step S21 to print one page.

Then, operation executes step S23 to add the print page value “1” to a count value N counted by the page counter 27. A default value of N is set to “0.”

Next, operation executes step S25 to determine whether the cumulative print page value N since the last calibration is equal to or more than the second threshold value (n+P), which is the first threshold value n plus the print page value P at the point where calibration is necessarily to be executed after exceeding the first threshold value n.

When a result of step S25 is “NO,” operation executes step S27 to determine whether the cumulative print page value N since the last calibration is equal to or more than the first threshold value n. Operation of when a result of step S25 is “YES” will be described hereinafter.

When a result of step S27 is “NO,” more specifically, when the print page value does not exceed the first threshold value, operation returns to step S21 to continue executing printing and repeats the subsequent steps.

When a result of step S27 is “YES,” operation executes step S29 for the control unit 11 to check the status of the print unit 25 to determine whether all pages of a job have been printed and the job has been completed. When a result of step S29 is “NO,” that is, if the job has not been completed, operation returns to step S21 and repeats the subsequent steps.

When a result of step S29 is “YES,” operation executes step S31 for the control unit 11 to check the status of the operation input unit 13 and the communication unit 17 to determine whether there is a waiting job instructed for printout. If a result of step S31 is “YES,” in other words, there is a waiting print job, operation returns to step S21 and repeats the subsequent steps.

When a result of step S31 is “NO,” operation executes step S33 to execute a calibration by determining that it is the appropriate time for executing a calibration, based on the results of a series of conditioning steps that the print page value has exceeded the threshold value and that there is neither a printing job nor a waiting job.

Next, operation executes step S35 to reset the cumulative print page value N since the last calibration, which is stored in the page counter 27, to “0,” then returns to step S21 and repeats the subsequent steps.

When a result of step S25 is “YES,” operation proceeds to step S33 to execute a calibration regardless of presence or absence of a waiting print job by determining that it is the point where the print page value exceeds the second threshold value (n+P). Further printing exceeding the second threshold value (n+P) will otherwise cause great deterioration of image quality. Operation further proceeds to execute step 35, returns to the first step S21, and repeats the subsequent steps.

Even when a calibration is not executed when the cumulative print page value has exceeded the threshold value, print quality remains unaffected up to certain pages of output. However, when print data is uninterruptedly received while the threshold value is exceeded, there is a high possibility for print quality to be lowered. Therefore, even when there is a printing job or a waiting job, once the print page value reach the second threshold value, a calibration is executed. Accordingly, in addition to effects to be achieved by the first preferred embodiment, the configuration of the second preferred embodiment can prevent deterioration of print quality by disallowing sequential printing to continue to the point where print quality becomes greatly lowered.

The present document incorporates by reference the contents of Japanese priority document, Japanese Patent Application No. 2006-010446, filed in Japan on Jan. 18, 2006.

Although the invention has been described with respect to specific embodiments for a complete and clear disclosure, the appended claims are not to be thus limited but are to be construed as embodying all modifications and alternative constructions that may occur to one skilled in the art which fairly fall within the basic teaching herein set forth. There are changes that may be made without departing from the spirit and scope of the invention.

Any element in a claim that does not explicitly state “means for” performing a specific function, or “step for” performing a specific function, is not to be interpreted as a “means” or “step” clause as specified in 35 U.S.C. 112, Paragraph 6. In particular, the use of “step(s) of” or “method step(s) of” in the claims herein is not intended to invoke the provisions of 35 U.S.C. 112, Paragraph 6.

What is claimed is:

1. An image forming device comprising:
a print means for performing print processing of a print job;
a calibration implementation means for performing a calibration on the print means;
a print page count means for counting a print page value;
a print job monitoring means for monitoring whether a following print job is waiting; and
a calibration control means for instructing the calibration implementation means to execute a calibration when the print page value counted by the print page count means has exceeded a designated threshold value and the print job monitoring means verifies that there is not a waiting print job.

2. An image forming device comprising:
a print means for performing print processing of a print job;
a calibration implementation means for performing a calibration on the print means;
a print page count means for counting a print page value;
a print job monitoring means for monitoring whether a following print job is waiting; and
a calibration control means for instructing the calibration implementation means to execute a calibration when the print page value counted by the print page count means has exceeded a first designated threshold value and the print job monitoring means verifies that there is not a waiting print job, and for instructing the calibration implementation means to execute a calibration regardless of presence or absence of a waiting print job when the print page value has exceeded a second threshold value.

3. A method for forming an image, comprising:
a print unit for performing print processing of a print job;
a calibration implementation unit for performing a calibration on the print unit;
a print page count unit for counting a print page value;
a print job monitoring unit for monitoring whether a following print job is waiting; and
a calibration control unit for instructing the calibration implementation unit to execute a calibration when the print page value counted by the print page count unit has exceeded a designated threshold value and the print job monitoring unit verifies that there is not a waiting print job.

4. The method of claim 3, wherein the calibration control unit for instructing the calibration implementation unit to execute a calibration when the print page value counted by the print page count unit has exceeded a first designated threshold value and the print job monitoring unit verifies that there is not a waiting print job, and for instructing the calibration implementation unit to execute a calibration regardless of presence or absence of a waiting print job when the print page value has exceeded a second threshold value.
